(19) United States
(12) Patent Application Publication
(10) Pub. No.: US 2004/0077364 A1
(43) Pub. Date: Apr. 22, 2004

(54) System and method for providing a group of subscribers with access to a wireless telecommunication system

(76) Inventor: Ming-Tsan Peng, Cambridge (GB)

Correspondence Address: Ming Tsan Peng, Parkers House, 48 Regent Street, Mail Box 441, Cambridge, CB2 1FD, GB

(21) Appl. No.: 10/467,001

(22) PCT Filed: Apr. 3, 2002
(86) PCT No.: PCT/GB02/01541

(30) Foreign Application Priority Data
Jun. 29, 2001 (GB) 0115945.8

(51) Int. Cl. H04B 7/00; H04Q 7/00

(52) U.S. Cl. 455/500; 455/422.1

(57) ABSTRACT

A system for providing broadcast services to a group of subscribers (106(1)) through (106(X)) in a telecommunication system (100), wherein each subscriber is provided with a subscriber unit, as (110(1)) through (110(X)). The subscriber units are able to access wireless telecommunication services provided by a base station (120). The base station (120) connects to a mobile telephone switching office (MTSO) (130), a public switched telephone network (PSTN) (140) and other cellular cites. In this system a control station (160), which may be in other cells (150), remotely instructs modem configuration in each subscriber unit activated to receive the services. The control station (160) provides configuration data to the subscriber units for modem configuration, wherein the configuration data are retrieved from a database (164) in the control station. The control station (160) uses a subscriber unit (162) to send the broadcast information when the subscriber units have completed the modem configuration.

### BACKGROUND OF THE INVENTION

I. Field of the Invention

The present invention relates to a method of providing wireless broadcast services for a group of subscribers, wherein each subscriber is provided with a subscriber unit. The method is suitable for a wireless telecommunication system, where it is possible for the subscribers situated differently to receive the same information via a common wireless channel. The method in this invention provides a procedure for supplying sufficient information so that proper configurations can be achieved for using such broadcast services.

II. Related Art

In a wireless telecommunication system, subscribers use subscriber units to access wireless telecommunication systems. A subscriber unit has a transceiver system to send or receive radio-wave frequency signals to or from a base station. The signals received are further processed by a modem, which is coupled to the transceiver system. The base station requires the unique authentication information (UAI) stored in the modem to identify the subscriber to prevent wireless fraud. The authentication information consists of static and dynamic authentication information. The static authentication information remains constant at all times, but the modem may modify the dynamic authentication information in response to an update message from a base station.

A modem provides signal-processing functions in order to recover the original information from the signals received by the transceiver system. When the modem is able to recover the information sent by a base station to the subscriber unit, it is accessing a wireless channel. The information-recovery capability of a modem depends on the telecommunication system it accesses. For example, a modem may follow a decoding mechanism to recover the original information.

In a wireless telecommunication system, the capability of a modem to recover the original information may be independent of the location of the modem. This independence may be achieved by a circuit capable of automatically adapting to a new location, for example, to overcome a difference in the signal propagation path. In this case, situating a modem in a new location should not diminish its information-recovery capability. Furthermore, if the radio signals reaching the original location also reach any possible new location to which the modem has been moved with enough power, then the modem should be able to work properly in any point of the cell covered by the base station. In a wireless telecommunication system with such properties, two identical modems should be able to receive the same information via the same wireless channel. If it is further possible for a modem to access any wireless channel by properly altering its configuration, then two configurable modems can be configured dynamically to access the same wireless channel.

An exemplar system that demonstrates the properties described above is the code division multiple access (CDMA) system. In a CDMA system, a modem uses a unique long-code sequence for signal spreading, which is the main factor for a modem in determining which wireless channel it is to access. All radio signals in a cell reach each point in the cell within a common spectrum. A wireless channel is, therefore, classified by its data content, regardless of the actual path. The term “wireless channel” refers to a logical channel in this document.

A wireless channel, herein, is referred to as a logical channel. In the CDMA system, a modem can access a particular wireless channel using correspondent long-code sequence. As well known in the art of the CDMA system, a modem has a linear-feedback shift register that produces the long-code sequence based on a particular initial vector, also referred to as the long-code seed.

In the systems described above, although it is possible for different modems located differently to receive the same information via a common wireless channel, in traditional systems the subscriber unit only serves for personal cellular services by being configured locally or without being configured. The locality refers to the fact that modem configuration is normally restricted by the subscriber unit itself or further with a base station. Thus, proper modem configuration cannot be achieved by a group of different subscriber units, even when the information can be received in a broadcast form from some subscriber unit, which may be situated in any other cellular site. What is required, therefore, is a centralized system, wherein there are databases to provide the required information for proper modem configuration in different subscriber units. The broadcast service then requires fewer wireless channels and so reduces the cost incurred by using a telecommunication service to which the receivers are connected.

### SUMMARY OF THE INVENTION

In the method of this invention, the broadcast information is sent to a representative modem (RM) through a wireless channel. When the representative modem is accessing the wireless channel, a number of modems in other subscriber units also receive the same information using the same wireless channel. However, the use of those modems is different from that of the representative modem because the base station is only aware of the use of the representative modem with normal authentication procedures using UAI. Since other modems do not follow the normal procedure to access the wireless channel, proper configuration in those modems is required to be completed before sending the broadcast information to the representative modem. Since it is possible to use multiple modems simultaneously in a subscriber unit, multiple representative modems can be used for the broadcast services. All the representative modems can come from a single subscriber unit, which is able to provide a set of UAIs for the modems to accept incoming calls simultaneously.

In the method of this invention, there is a group of subscriber units with access to a wireless telecommunication system, wherein each subscriber is provided with a subscriber unit. A subscriber unit has one or a plurality of modems, and different modems in a subscriber unit can receive information independently. In an embodiment, the group of subscriber units contains a subgroup, in which each subscriber unit can make at least one modem able to receive information via normal use with a base station using its own UAI. A subscriber unit can therefore use at least one of its modems to receive information with some incoming calls.

The information required by modem configuration in order to access a wireless channel is, herein, referred to as the configuration data (CD) associated with the wireless channel. Configuration data can appear in the form of messages which can be transmitted via a telecommunication system and can be stored or retrieved from a database. The configuration data associated with a wireless channel are, herein, preferably the minimum set of data required by a configurable modem to be configured to access the associated wireless channel.

When a broadcast service is initialized, the subscriber units to be sent the broadcast information are selected and activated. The activation may be done by some command message sent to a stand-by subscriber unit to inform it that a broadcast service is being initialized. Of the activated subscriber units, there are a number of subscriber units coming from the subgroup of subscriber units. A representative modem is then selected from the activated subscriber units in the subgroup as the modem is able to possess the UAI to receive an incoming call. An available modem in each activated subscriber unit possessing a plurality of modems is also selected to be designated or a modem in each subscriber unit is designated for receiving the broadcast information in a later stage through the wireless channel to be accessed by the representative modem. An incoming call will be established with the representative modem after its subscriber unit has stored static and dynamic authentication information in the representative modem. The configuration data associated with the wireless channel are supplied to the each designated modem for configuration. After all designated modems have synchronized with the wireless channel, the broadcast information can then be sent via the wireless channel by the caller who originates the incoming call to the representative modem. Thus, the broadcast information will be also received by other non-representative modems.

The subscriber unit having the designated modem to be configured may need to supply the configuration data associated with the wireless channel; Or the subscriber unit itself also requires an outside source to provide the required configuration data in order to provide those configuration data to the modem. The outside source of configuration data may be a database, which may be remote from the subscriber unit. The database then provides the required configuration data to all the subscriber units requiring the configuration data to be supplied to their designated modems for configuration. To establish such a database, the configuration data associated with the wireless channel possible to be used by a representative modem has to be stored, so that it can be retrieved when necessary.

It is likely that prior to establishing a wireless channel, the base station will provide some information to a subscriber unit for modem configuration, and the information will be part or all of the configuration data associated with the wireless channel. When a representative modem is receiving an incoming call, its subscriber unit can obtain the configuration data, which may contain some information provided from the base station. The subscriber unit having the representative modem can then send the part of the configuration data obtained from the base station to other subscriber units for modem configuration. Alternatively, instead of providing the configuration data directly through the subscriber unit having the representative modem, the part of the configuration data can be provided to the database to be stored and re-distributed to other subscriber units requiring the configuration data.

If all the activated subscriber units are of the subgroup, then a subscriber unit can store static and dynamic authentication information to a modem for receiving information from an outside source, so as to receive the configuration data from the database or the subscriber unit having the representative modem. Alternatively, if some activated subscriber units are not of the subgroup, then a non-member subscriber unit can receive the configuration data from a different telecommunication network such as a local telephone network.

In another embodiment, in the method of this invention, the subscriber unit possessed by each subscriber is unable to provide UAI to an available modem to receive information required by the broadcast service. In this embodiment, there is a group of subscribers as proxy subscribers, and each proxy subscriber is associated with one unique set of static and dynamic authentication information. A modem in a subscriber unit that is not of a proxy subscriber can use the UAI associated with a proxy subscriber temporarily to receive information. In such a case, the UAI associated with the proxy subscribers may be the properties appropriated by the sender of the broadcast information; therefore the UAI associated with a proxy subscriber can only be used for the purpose of receiving the broadcast service by a subscriber unit. The set of UAIs associated with the group of proxy subscribers are then stored in a database.

When a broadcast service is initialized, the subscriber units are selected and activated. A representative modem is selected from one of these activated subscriber units, with an available modem being also selected to be designated from each one of the other activated subscriber units possessing a plurality of modems or a modem being designated from each of the other activated subscriber units. In order to enable the representative modem to receive an incoming wireless call, static and dynamic authentication information has to be stored in the modem. Then the sender of the broadcast information establishes a wireless channel by making an incoming call to the representative modem. The configuration data associated with the wireless channel are then supplied to each designated modem for configuration. After all modems have been configured, the sender can send the broadcast information to the representative modem via the same wireless channel.

The UAI associated with a proxy subscriber can be retrieved from the database and can be provided to the subscriber unit having the representative modem. The static and dynamic authentication information is then stored in the representative modem to enable it to receive an incoming call. Similarly, the UAI associated with other proxy subscriber units can be also supplied to other subscriber units having designated modems in order to provide the UAI to a certain modem for the purpose of receiving configuration data from an outside source. A modem receiving the UAI associated with a proxy subscriber may modify dynamic authentication information in response to receiving an update message from the base station. After a subscriber unit has finished the use of the UAI associated with a proxy subscriber, the subscriber unit sends the updated dynamic authentication information to the database which stores the set of UAIs associated with the proxy subscribers.

Since, in this embodiment, a subscriber unit may have no available modem which has a stored UAI for receiving an incoming call to receive the UAI associated with a proxy subscriber, a subscriber unit can use a different telecommunication system such as a local telephone network to receive the UAI.

In a centralized embodiment, the method of this invention can further include a control station for serving the broadcast services. The control station has a database to store configuration data, and possesses a subscriber unit, which has a plurality of modems. The control station can use the subscriber unit to send the broadcast information using multiple modems simultaneously. However, the subscriber unit of the control station may be in a different cell in which the group of subscriber units receiving the broadcast services are situated. When a broadcast service is initialized, the control station determines and selects the subscriber units to be activated, selects a representative modem, selects an available modem to be designated in each of the other subscriber units possessing a plurality of modems or designates a modem in each of the other subscriber units. The control station then initiates an incoming call to the representative modem to establish a wireless channel. The control station also sends command messages to the subscriber units to instruct modem configuration and provides the required configuration data associated with the wireless channel to the subscriber units. Using the same wireless channel, the control station uses its subscriber unit to send the broadcast information to the representative modem.

In the centralized system, the control station can further comprise a database to store a set of UAIs associated with a group of proxy subscribers. The control station retrieves the UAI associated with a proxy subscriber from the database for providing the UAI to one of the subscriber units receiving the broadcast service. Since dynamic authentication information may be modified by a modem using the UAI associated with a proxy subscriber, the updated dynamic authentication information needs to be provided to the database and to be stored by the control station.

The centralized system can also be used with the embodiment in which the group of subscriber units contains a subgroup. In the subgroup, each subscriber unit can provide the UAI associated with its subscriber to at least one modem. In such an embodiment, the proxy subscribers may not be required, because a subscriber unit may use its modem as a representative modem to receive configuration data.

The control station also retrieves configuration data from the database which stores configuration data in order to provide it to other activated subscriber units. The control station may also receive part of configuration data obtained from the base station, and store it in the database.

In the exemplar wireless telecommunication system, that is, the CDMA system, the configuration data required by a modem is for the purpose of producing the long-code sequence so that the modem can access a particular wireless channel. The configuration data may be referred to the long code seed, which is an initial vector used by a linear-feedback shift register to produce the correspondent long-code sequence, as is well known in the art of CDMA systems. Furthermore, it is also possible that the configuration data needs to consist of the information from the base station as an instruction for modem configuration, for example, to select the proper long-code seed. The CDMA system, however, only serves as an example, since different telecommunication systems may also appear suitable for this invention. The application field of the method of this invention can then be broadened with a different system.

To summarize, one advantage of this invention is that a broadcast service can be provided using fewer wireless channels. A control station which a group of subscribers are registered for such broadcast services can broaden the field of application of the subscriber units, which are used for normal telecommunication purposes. Alternatively, a subscriber unit can have multiple modems, where a considerable number of modems are used for the broadcast service. However, a subscriber unit would require a unit, such as a microprocessor for providing the computing functions, as a number of computing activities may be performed when a modem is instructed by command messages from the control station or sends a response message to the control station. To fulfill such tasks, a subscriber unit may have to install the software enabling it to interact with the software in the control station. As is well known in the art of distributed computing, such software systems are able to transmit a request command message to each other, and accordingly obtain the response from the other end. The software installed can then perform proper computing functions to control the hardware, such as the microcomputer in a subscriber unit and other devices such as a modem. The distributed computing system can use proper network protocol binding to ensure effective use of a telecommunication system to transmit data or command messages. Through the use of a distributed computing system, the control station can activate the remote subscriber units selected, and further instruct a subscriber unit to select an available modem to be configured, or to be stored with authentication information e.t.a.

### BRIEF DESCRIPTION OF THE FIGURES

A specific embodiment of the invention will now be described by way of example with reference to the accompanying drawing in which:

FIG. 1 shows a wireless telecommunication system with a control station;

FIG. 2 shows an exemplar subscriber unit, which has a plurality of modems;

FIG. 3 illustrates how the sheets of FIGS. 4, 5 and 6 are interrelated;

FIGS. 4, 5 and 6 comprise a flowchart of a preferred centralized system offering broadcast services.

### DETAILED DESCRIPTION OF THE PREFERRED EMBODIMENTS

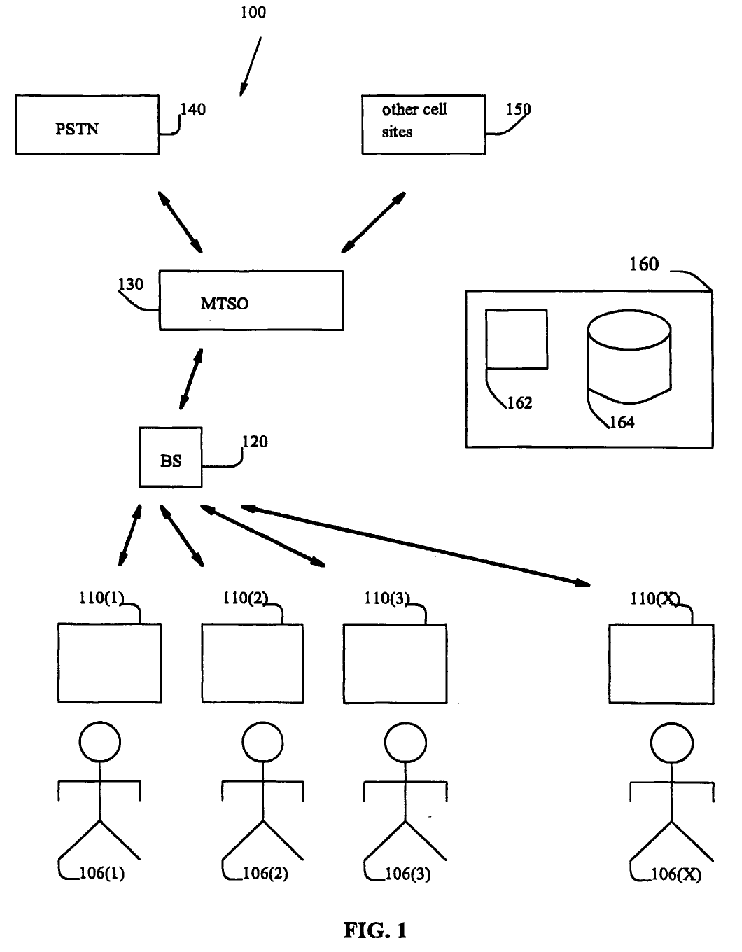

FIG. 1 shows a wireless telecommunication system 100, which further includes a control station 160 to provide broadcast services. In the system 100, there is a group of subscribers 106(1) through 106(X), in which each subscriber is provided with a subscriber unit from 110(1) through 110(X) respectively. When a subscriber unit is used, the base station allocates wireless channels for information transmission. The base station 120 routes traffic to or from a mobile telephone switching office (MTSO) 130, which connects to a public switched telephone network (PSTN) 140 and to other cellular cites. The control station 160 may be in a cell other than that of the base station 120, but when sending information to the subscriber units, wireless channels have to be used between the base station 120 and the subscriber units. The control station 160 also possesses a subscriber unit 162 for sending broadcast information, and a database 164 to store configuration data to be provided to a subscriber unit for modem configuration.

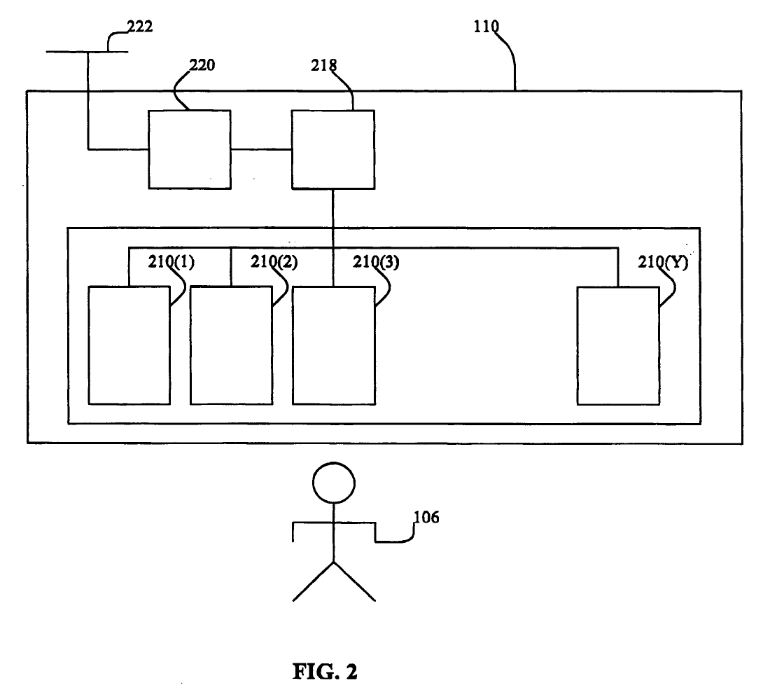

FIG. 2 shows a typical subscriber unit 110 associated with a subscriber 106, which consists of a plurality of modems, 210(1) through 210(Y). In this example, the modems are coupled to a transceiver system by the modem interface 218. The transceiver system consists of an antenna 222 and the antenna interface 220. In this exemplar embodiment, a subscriber unit has to provide authentication information to its modem when the modem is used for receiving information through formal telecommunication service provided by the base station 120. A subscriber unit, however, can use a different telecommunication system, such as a local telephone network to receive data such as configuration data, if a wireless modem is not used for this purpose. Furthermore, possession of the plurality of modems just shows an example of using multiple modems, however, the subscriber unit having only a single modem can be also used in such embodiment.

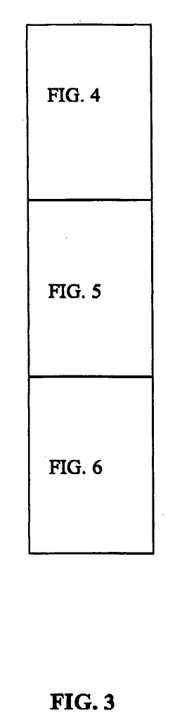

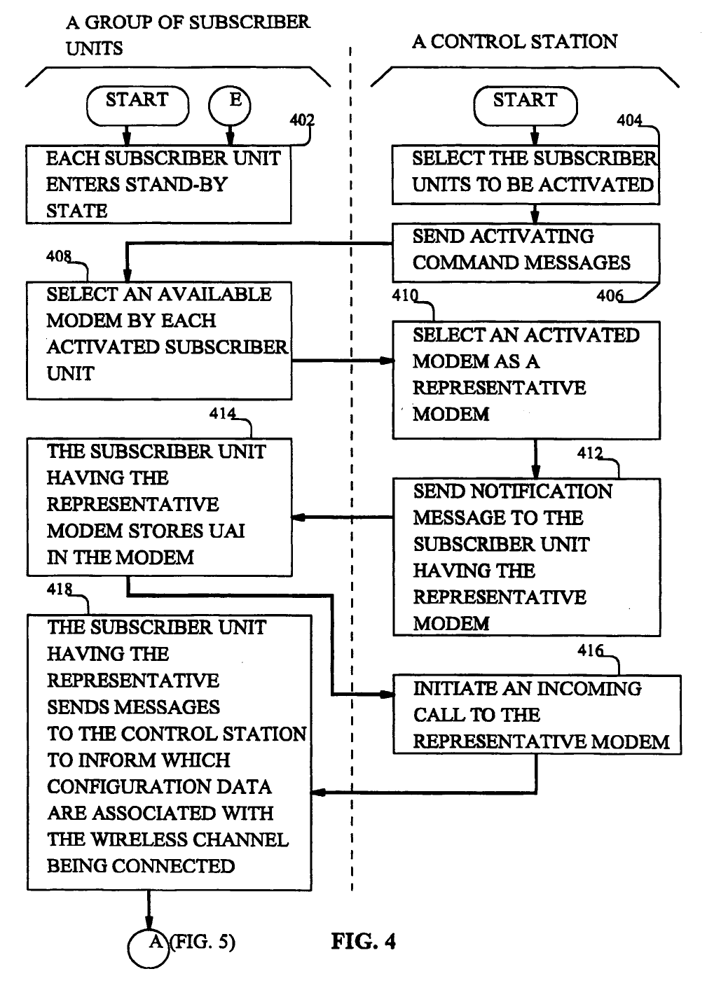

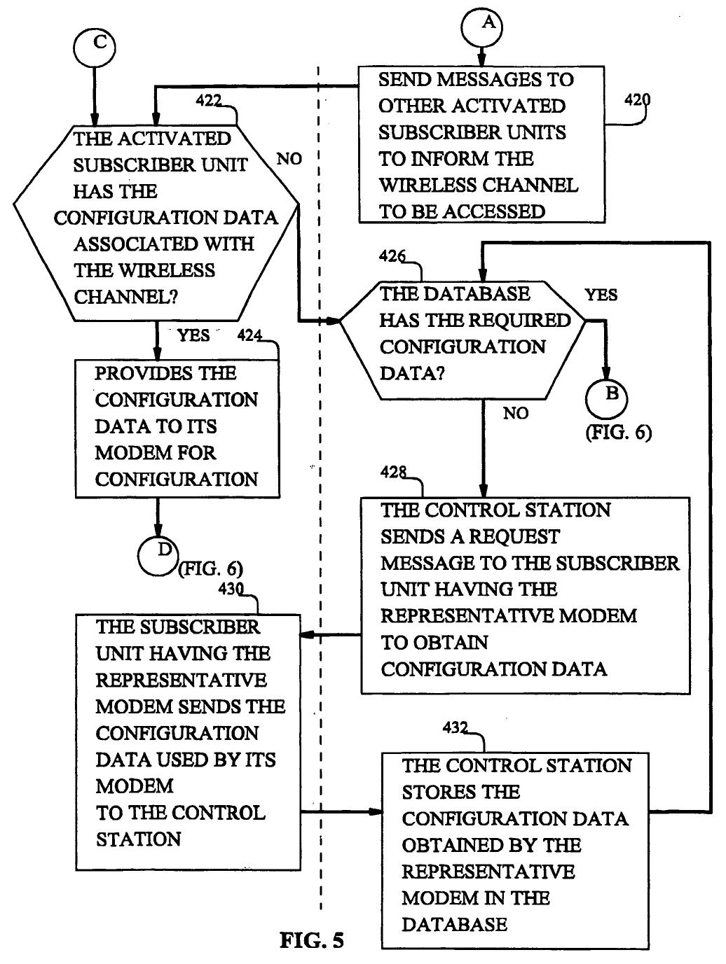

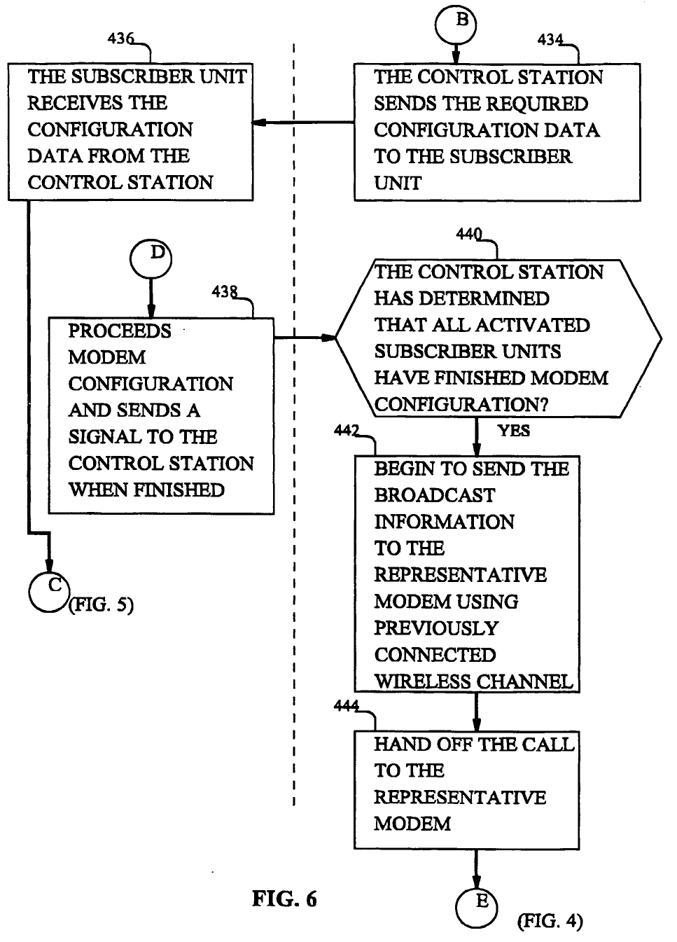

FIG. 3 shows how FIGS. 4, 5 and 6 are interrelated as a flowchart in FIGS. 4, 5 and 6, the flowchart is shown in two parts: the activities in the group of subscriber units 110(1) through 110(X), and those at the control station 160. Communication is required between these two parts when a broadcast service is to be achieved. In step 402, all subscriber units are in stand-by state, to be informed and activated to receive the broadcast service. The control station 160, in step 404, selects the subscriber units to be activated. In step 406, the control station 160 sends command messages to the subscriber units to be activated. In step 408, the subscriber unit activated then selects an available modem to be configured to receive the broadcast information later. In step 410, the control station 160 selects one modem as a representative modem from one of the activated subscriber units. After the control station 160 informs the subscriber unit having the representative modem in step 412, the UAI has to be stored in its selected modem, in case the modem has no UAI itself. With the UAI stored, the representative modem is then able to receive an incoming call, which will be initiated by the control station 160 in step 416 using its subscriber unit 162. In step 418, the subscriber unit having the representative modem then informs the control station 160 which wireless channel has been accessed, so that proper modem configuration in other subscriber units can follow. In step 420, the control station 160 sends messages to each subscriber unit to inform it of the wireless channel to be accessed. In step 422, if the subscriber unit has all the required configuration data, then the data will be provided to the modem in step 424. Otherwise, the control station 160 has to provide the configuration data from the database 164 in step 434. However, the database 164 may not have the complete configuration data in step 426, and the control station 160 will inform the subscriber unit having the representative modem in step 428, so that the subscriber unit can send the configuration data it used for modem configuration to the control station 160 in step 430. In step 432, the control station 160 stores the received configuration data in the database 164. After the control station 160 makes sure that the database 164 has all the required configuration data in step 426, the sending of configuration data will be done by the control station 160 in step 434. In step 436, the subscriber unit requiring the configuration data associated with the wireless channel being accessed by the representative modem will then receive the configuration data. After step 424, the modem to be configured can use the configuration data for configuration in step 438; its subscriber unit will send a signal to the control station 160 to indicate that the modem configuration has been completed. In step 440, when the control station 160 knows all the activated subscriber units are able to access the same wireless channel it used to connect to the representative modem, the control station 160, in step 442 can begin to send the broadcast information using the incoming call it has established with the representative modem. In step 444, the control station 160 hands off the call after the broadcast information has been sent. Then all the activated subscriber units enter stand-by state as in step 402.

What is claimed is:

1. A method for providing a group of subscribers with broadcast services in a wireless telecommunication system, wherein each subscriber is provided with a subscriber unit, a subscriber unit possesses one modem or a plurality of modems, and the group of subscriber units contains a subgroup, in which each subscriber unit has at least one set of static and dynamic authentication information associated with its subscriber, comprising the step of:
(a) activating the subscriber units to receive broadcast information, including some subscriber units in said subgroup of subscriber units;
(b) selecting an available modem as a representative modem in a subscriber unit in said subgroup of subscriber units;
(c) selecting an available modem in each of said activated subscriber units possessing a plurality of modems;
(d) designating a modem in each said activated subscriber unit, wherein the modem designated in a subscriber unit possessing a plurality of modems is said selected modem;
(e) storing static and dynamic authentication information in said representative modem;
(f) establishing a wireless channel to be used by said representative modem for receiving said broadcast information with a base station;
(g) providing the configuration data associated with said wireless channel to each said designated modem;
(h) configuring each said designated modem using said configuration data; and
(i) sending said broadcast information to said representative modem.

2. The method of claim 1, wherein a representative modem is only selected from a plurality of modems in a particular subscriber unit possessing a plurality of modems.

3. The method of claim 1, wherein said configuration data provided to each said designated modem are provided by the subscriber unit having that said designated modem.

4. The method of claim 3, further comprising the step of providing configuration data to each said subscriber unit having said designated modem, wherein the configuration data provided to the subscriber unit are part or all of said configuration data provided to said designated modem.

5. The method of claim 4, further comprising the step of storing in a database the configuration data associated with said wireless channel accessed by said representative modem.

6. The method of claim 5, further comprising the step of retrieving said configuration data from said database, wherein the configuration data retrieved from said database are provided to each said subscriber unit having said designated modem.

7. The method of claim 6, further comprising the step of obtaining part or all of the configuration data associated with said wireless channel from said base station.

8. The method of claim 7, wherein the subscriber unit having said representative modem is used to obtain said configuration data associated with said wireless channel from said base station.

9. The method of claim 8, further comprising the step of providing said configuration data obtained form said base station to each said subscriber unit having said designated modem by the subscriber unit having said representative modem.

10. The method of claim 8, further comprising the step of storing in said database said configuration data obtained from said base station by the subscriber unit having said representative modem.

11. The method of claim 6 or 9, wherein a said activated subscriber unit having said designated modem which is not said representative modem may be selected from said subgroup of subscriber units.

12. The method of claim 11, further comprising the step of storing in a modem static and dynamic authentication information associated with the subscriber of said subscriber unit having said designated modem, wherein the modem provided with said static and dynamic authentication information is used for receiving said configuration data provided to said subscriber unit.

13. The method of claim 6 or 9, wherein a said activated subscriber unit may use a different telecommunication system from said wireless telecommunication system, such as a local telephone network to receive configuration data.

14. A method for providing a group of subscribers with broadcast services in a wireless telecommunication system, wherein each subscriber is provided with a subscriber unit, and a subscriber unit has one modem or a plurality of modems, a group of proxy subscribers who are not of said group of subscribers, each of the proxy subscribers is associated with unique static and dynamic authentication information, and there is a database storing said authentication information, comprising the step of:
(a) activating the subscriber units to receive broadcast information;
(b) selecting an available modem as a representative modem;
(c) selecting an available modem in each one of said activated subscriber units possessing a plurality of modems;
(d) designating a modem in each said activated subscriber unit, wherein the modem designated in a subscriber unit possessing a plurality of modems is said selected modem;
(e) storing static and dynamic authentication information in said representative modem;
(f) establishing a wireless channel to be used by said representative modem for receiving said broadcast information with a base station;
(g) providing the configuration data associated with said wireless channel to each said selected modem;
(h) configuring each said selected modem using said configuration data; and
(i) sending said broadcast information to said representative modem.

15. The method of claim 14, further comprising the step of retrieving static and dynamic authentication information from said database.

16. The method of claim 15, further comprising the step of providing static and dynamic authentication information to the subscriber unit having said representative modem, wherein the static and dynamic authentication information provided to the subscriber unit is the static and dynamic authentication information retrieved from said database.

17. The method of claim 15, further comprising the step of providing static and dynamic authentication information to a said subscriber units having said designated modem, wherein the static and dynamic authentication information provided to the subscriber unit is the static and dynamic authentication information retrieved from said database.

18. The method of claim 16 and 17, further comprising the step of storing in a modem said static and dynamic authentication information, wherein said static and dynamic authentication information provided to the modem is said static and dynamic authentication information retrieved from said database and provided to the subscriber unit.

19. The method of claim 18, wherein said modem receiving said static and dynamic authentication information modifies the dynamic authentication information in response to receiving an update message from said base station.

20. The method of claim 19, further comprising the step of storing said updated dynamic authentication information in said database.

21. The method in any preceding claim, wherein the transmission of the static and dynamic authentication information is via a different telecommunication system from said wireless telecommunication system, such as a local telephone network.

22. A centralized system, wherein there is a control station for providing a group of subscribers with broadcast services in a wireless telecommunication system, each subscriber is provided with a subscriber unit, a subscriber unit has one modem or a plurality of modems, and there is a number of subscribers, each of which is associated with unique static and dynamic authentication information, wherein said a number of subscribers form a subgroup in said group of subscribers or a group of proxy subscribers who are not of said group of subscribers; the control station is the sender of broadcast information, comprising:
a plurality of modems for sending broadcast information to representative modems through wireless channels provided by a base station; and
a database storing the configuration data associated with the wireless channels to be accessed by representative modems; wherein
said control station determines the subscriber units to be activated, designates a representative modem, designates a modem in each activated subscriber unit including the selection of an available modem to be designated in case of a subscriber unit possessing a plurality of modems, establishes a wireless channel connecting to said representative modem by initiating an incoming call to said representative modem, instructs each subscriber unit having said designated modem to do modem configuration by sending command messages, provides the configuration data associated with said wireless channel, and sends the broadcast information to said representative modem.

23. The centralized system of claim 22, further comprising a database in said control station for storing the static and dynamic authentication information associated with said a number of subscribers.

24. The centralized system of claim 23, wherein the static and dynamic authentication information provided to an activated subscriber unit is retrieved by said control station from said database which stores authentication information.

25. The centralized system of claim 23, wherein the dynamic authentication received from an activated subscriber unit is stored by said control station in said database which stores authentication information.

26. The centralized system of any preceding claim, wherein the configuration data provided to an activated subscriber unit is retrieved by said control station from said database which stores configuration data.

27. The centralized system of any preceding claim, wherein the configuration data received from an activated subscriber unit is stored by said control station in said database which stores configuration data.

28. A centralized system substantially as described herein with reference to FIGS. 1-6 of the accompanying drawing.
